(19) United States
(12) Patent Application Publication
(10) Pub. No.: US 2026/0362096 A1
(43) Pub. Date: Nov. 12, 2026

(54) METHODS, ARCHITECTURES, APPARATUSES AND SYSTEMS FOR CONSTRUCTING PROTOCOL DATA UNIT SETS

(71) Applicant: InterDigital Patent Holdings, Inc., Wilmington, DE (US)

(72) Inventors: Magurawalage Chathura Madhusanka Sarathchandra, London (GB); Michael Starsinic, Newtown, PA (US); Jung Je Son, Warrington, PA (US); Alain Mourad, Ascot (GB); Laksh Bhatia, London (GB); Taimoor Abbas, Sainte-Julie (CA); Sebastian Robitzsch, London (GB); Carlos Jesus Bernardos, Madrid (ES); Muhammad Awais Jadoon, London (GB)

(21) Appl. No.: 19/202,665

(22) Filed: May 8, 2025

(51) Int. Cl. H04W 4/38; H04W 28/02; H04W 28/24

(52) U.S. Cl. CPC H04W 4/38; H04W 28/0268; H04W 28/24

(57) ABSTRACT

This disclosure is related to generating protocol data unit (PDU) sets. A method includes receiving, from a wireless network, sensing data grouping information, generating sensing data associated with a sensing task, wherein the sensing data comprises a plurality of sensing data portions, generating, based on the sensing data grouping information, at least one protocol data unit (PDU) set that includes the plurality of sensing data portions and PDU set information, wherein the PDU set information indicates a respective grouping for each of the plurality of sensing data portions, and transmitting, to the wireless network, as part of a PDU session, the at least one PDU set according to at least one set of quality of service (QoS) rules, wherein each set of QoS rules of the at least one set of QoS rules is applied to a respective grouping of the at least one PDU set.

### TECHNICAL FIELD

The present disclosure is generally directed to the fields of communications, software and encoding/decoding, including, for example, to methods, architectures, apparatuses, systems related to constructing protocol data unit (PDU) sets based on performance monitoring.

### BACKGROUND

A protocol data unit (PDU) set may generally refer to a set of data that is transmitted over a network. A PDU set may be configured by the application layer of a single application by populating the headers of application layer messages. That information in the headers can indicate, to a wireless network, which messages are part of a given PDU set. In such a system, an application layer may need to use a protocol, such as real-time transport protocol (RTP) with specific RTP header extensions, to embed the PDU set information in the application layer traffic.

### SUMMARY

Relying on a single application layer to construct PDU sets is ill suited for grouping together correlated data coming from different sensors. For example, there may be different sensing applications operating on a single device, and an application layer of a network coupled to the device would not be readily configured to correlate data from those different sensing applications. Therefore, in connection with certain representative embodiments of this disclosure, a wireless transmit/receive unit (WTRU) may be configured to construct a PDU set. In particular, the WTRU may be configured to use sensing data units in sensing data streams to construct PDU sets and, e.g., transmit the PDU sets over an uplink (UL) connection to a network.

Procedures, methods, architectures, apparatuses, systems, and devices are provided for generating PDU sets. A method includes receiving, from a wireless network, sensing data grouping information, generating sensing data associated with a sensing task, wherein the sensing data comprises a plurality of sensing data portions, generating, based on the sensing data grouping information, at least PDU set that includes the plurality of sensing data portions and PDU set information, wherein the PDU set information indicates a respective grouping for each of the plurality of sensing data portions, and transmitting, to the wireless network, as part of a PDU session, the at least one PDU set according to at least one set of quality of service (QoS) rules, wherein each set of QoS rules of the at least one set of QoS rules is applied to a respective grouping of the at least one PDU set.

In certain representative embodiments, transmitting the at least one PDU set according to at least one set of QoS rules includes applying each of the at least one PDU set to a shared QoS flow.

In certain representative embodiments, receiving the sensing data grouping information comprises receiving, at an enabler client of the WTRU, the sensing data grouping information, and wherein the method further comprises receiving, at the enabler client, information about at least one sensor or about at least one type of sensing data from a sensing application of the WTRU.

In certain representative embodiments, the method also includes communicating the sensing data grouping information from an enabler client of the WTRU to a sensing application of the WTRU.

In certain representative embodiments, the method also includes communicating the plurality of sensing data portions from a sensing application of the WTRU to an enabler client of the WTRU.

In certain representative embodiments, generating the at least one PDU set includes indicating the PDU set information in a header of at least one message of the PDU session

In certain representative embodiments, generating the at least one PDU set includes indicating the sensing data grouping information in a header of at least one message of the at least one PDU set.

In certain representative embodiments, generating the at least one PDU set includes indicating at least one of: a last PDU of the at least one PDU set, a last data burst of the at least one PDU set, an importance of the at least one PDU set, at least one sequence number of the at least one PDU set, at least one size of the at least one PDU set, or a number of PDUs in the at least one PDU set

In certain representative embodiments, the sensing data grouping information includes at least one of: a time slot, a data frame, a target object, a target scene, a target object feature, a target object property, a sensing sub-area, a sensor, a type of sensing data, a degree of fusion, a degree of processing, a type of processing, a degree of duplication, a correlation indicator, a correlation identification, at least one sensing data priority level, or a sensing task identification

In certain representative embodiments, the method also includes determining, based on the sensing group information, sensing data portions of the plurality of sensing data portions to include in the at least one PDU set.

In certain representative embodiments, the sensing data grouping information includes an indication that a plurality of sensors of the WTRU will support the sensing task; and the plurality of sensing data portions includes respective sensing data portions from respective sensors of the plurality of sensors.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 1E is a system diagram illustrating an example core network that includes hardware and software for implementing the functionality of network functions included in the core network, such as those illustrated in FIG. 1A, according to one or more embodiments of this disclosure;

FIG. 2 shows an illustrative reference model of a wireless network, according to one or more embodiments of this disclosure;

FIG. 3 illustrates an example of pedestrian and/or animal intrusion detection, according to one or more embodiments of this disclosure;

FIG. 4 illustrates an example of intruder detection in the surroundings of a smart home, according to one or more embodiments of this disclosure;

FIG. 5A illustrates an example of multiple access channel with mono-static base station sensing, according to one or more embodiments of this disclosure;

FIG. 5B illustrates an example of a multiple access channel with bi-static base station sensing, according to one or more embodiments of this disclosure;

FIG. 6A shows a sequence diagram for a first part of an illustrative process for constructing PDU sets at a sensing entity, according to one or more embodiments of this disclosure;

FIG. 6B shows a sequence diagram for a second part of the illustrative process of FIG. 6A for constructing PDU sets at a sensing entity, according to one or more embodiments of this disclosure; and

FIG. 7 shows a flowchart of illustrative steps for constructing PDU sets at a WTRU, according to one or more embodiments of this disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

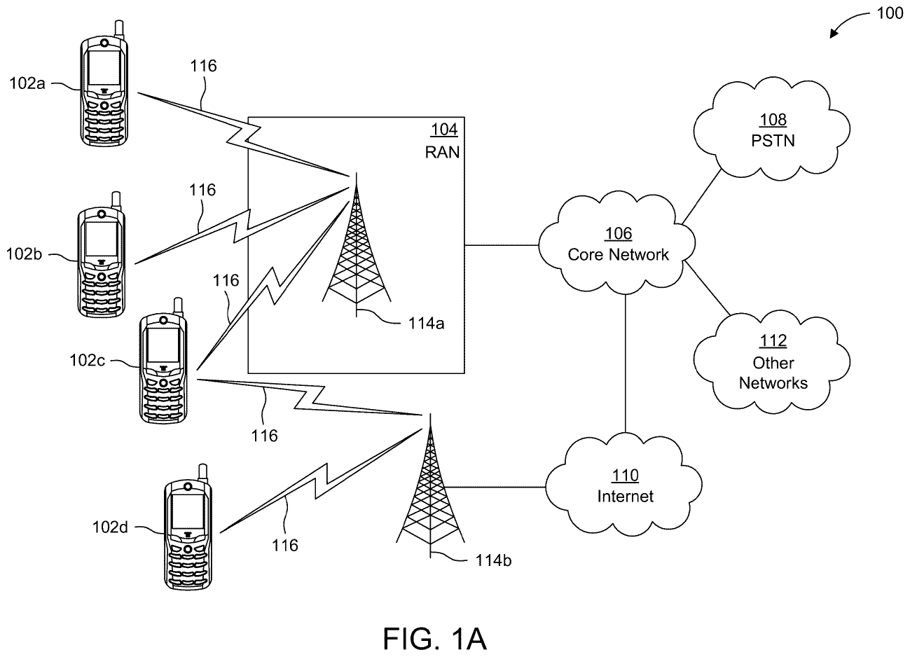

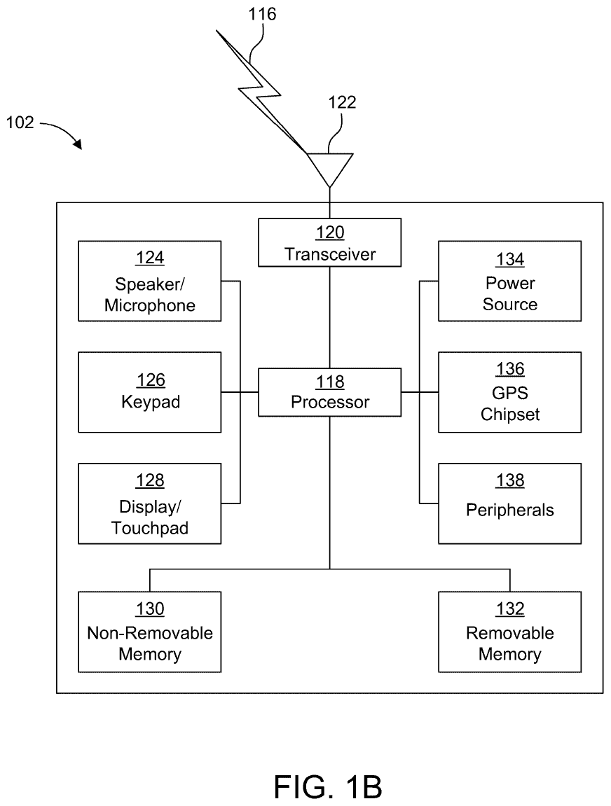

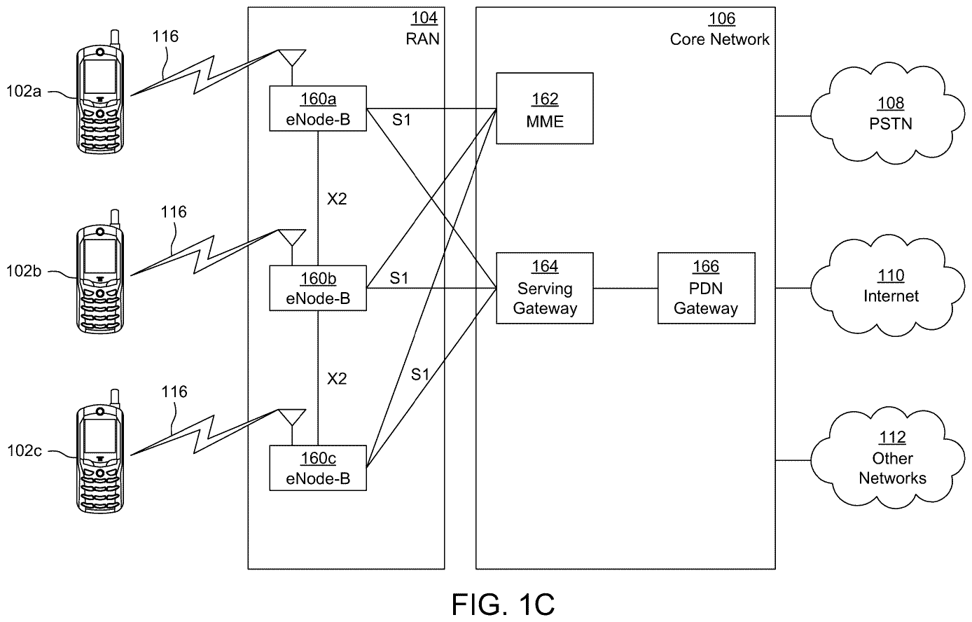

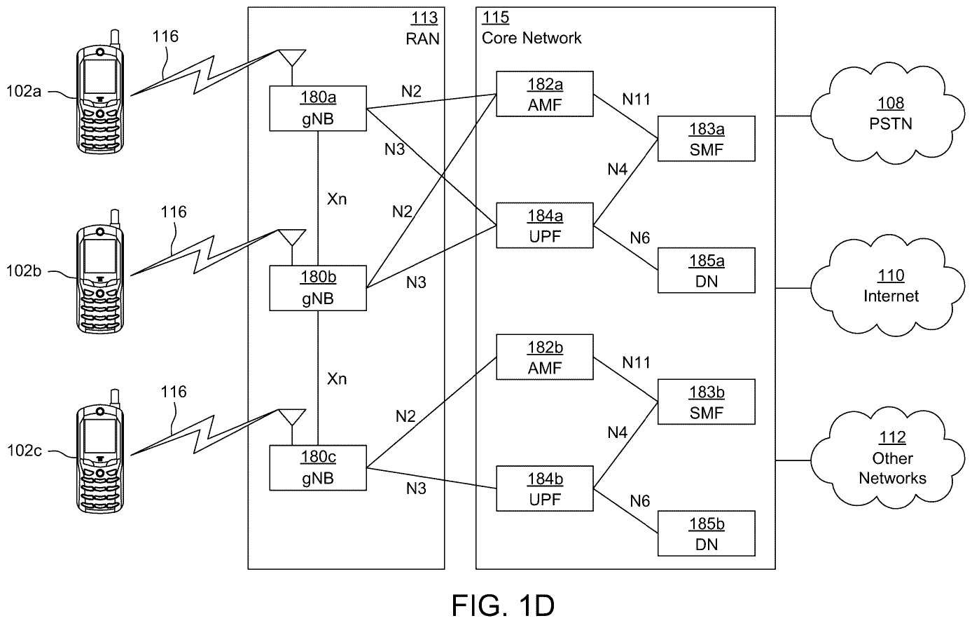

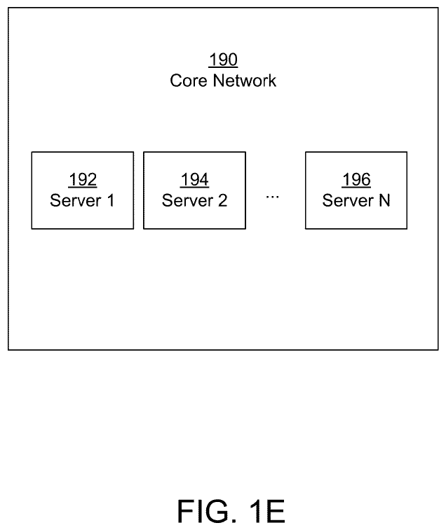

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) one or more user equipment (UE) components, a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE, and vice versa, for example, if the WTRU includes only one active UE.

As used herein, a sensing entity (interchangeably also referred to as a sensing device, a sensor, a sensor node, or a sensing node) may refer to any device that can perform sensing based on a wireless signal, including but not limited to any of the WTRUs 102a, 102b, 102c and 102d, any UE, any base station (e.g., base station 114a of RAN 104, or base station 114b), any suitable eNode-B (e.g., any eNode-B 160a, 160b, or 160c), any suitable gNode-B (e.g., any gNode-B 180a, 180b, or 180c), any hardware of a core network (e.g., hardware configured to execute any access and mobility function (AMF), user plane function (UPF), session management function (SMF) or data network (DN) of a core network), or any other suitable device.

The communications systems 100 may also include a base station 114a and/or a base station 114b. Each of the base stations 114a, 114b may be any type of device configured to wirelessly interface with at least one of the WTRUs 102a, 102b, 102c, 102d, for example, to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, that is, one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b need not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment. It will be appreciated that the WTRU 102 may include multiple iterations of any the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, for example, in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

As mentioned, although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and/or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode need not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards UPFs 184a, 184b, routing of control plane information towards AMFs 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one SMF 183a, 183b, and at least one DN 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, for example, to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The MME 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, for example, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

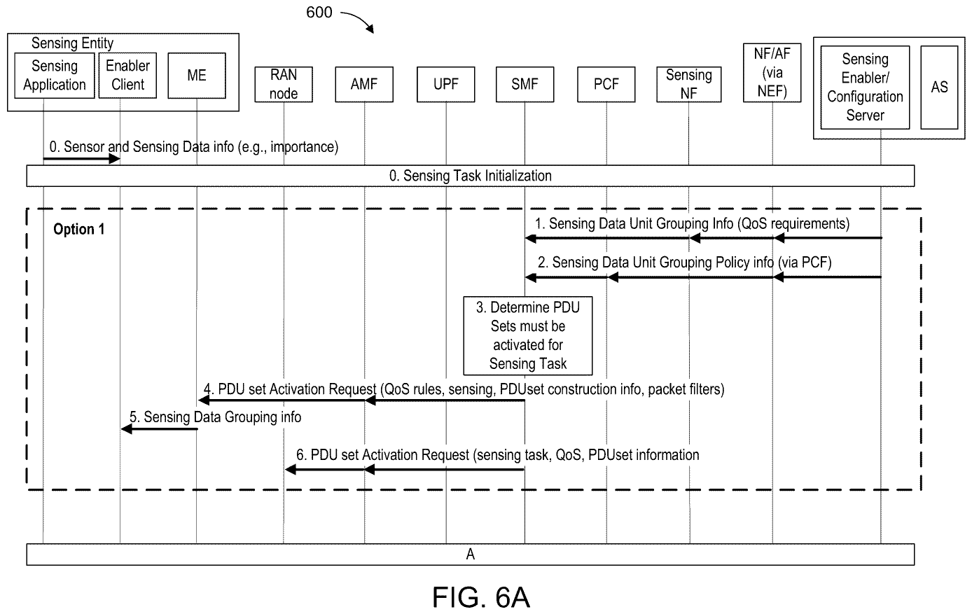

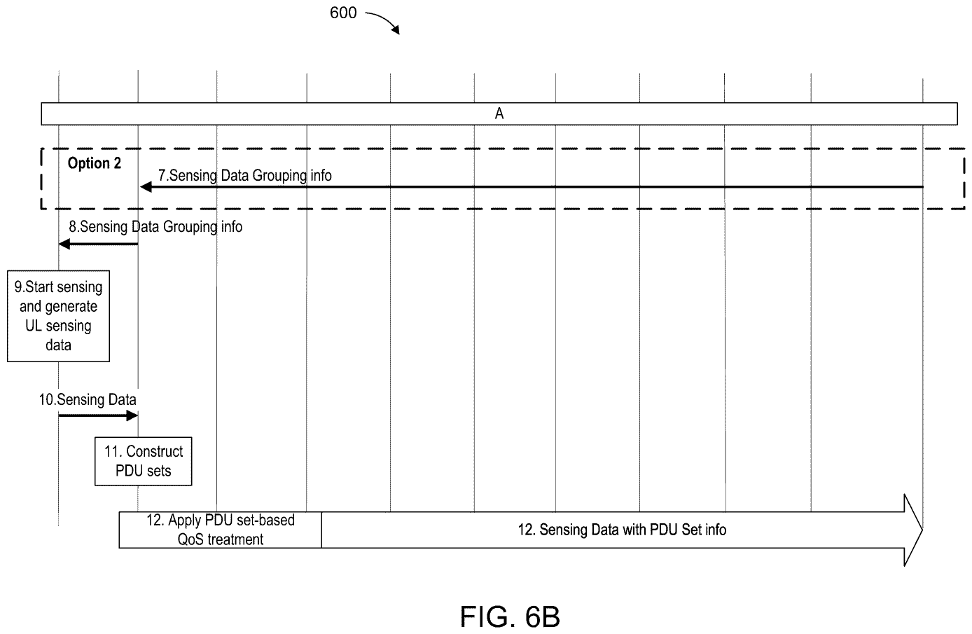

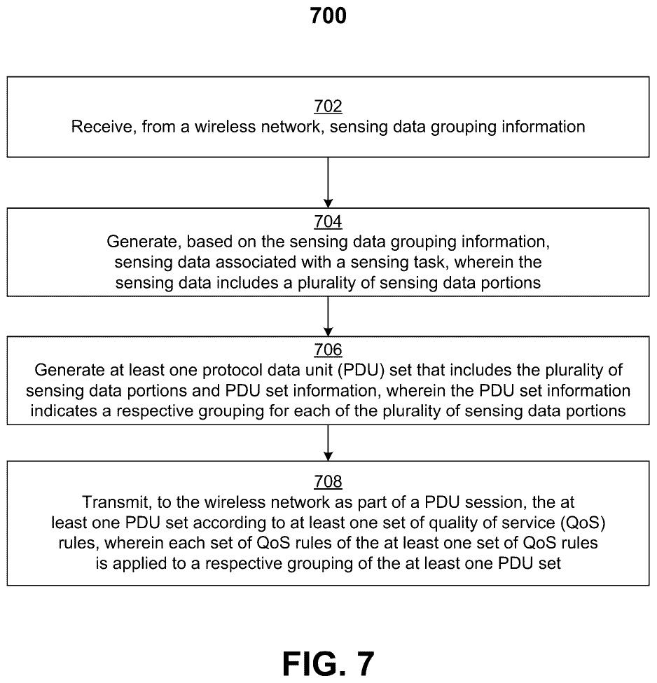

FIG. 1E is a system diagram illustrating an example core network that includes hardware and software for implementing the functionality of network functions included in the core network, such as those illustrated in FIG. 1A, according to one or more embodiments of this disclosure. Core network 190 may correspond to any of previously described core networks 103 or 115. Core network 190 may be implemented using any suitable hardware, software, or both. For purposes of illustration, and not by way of limitation, core network 190 is described herein as being implemented using one or more of servers 192-196 and may include at least one processor (e.g., configured to perform any one or more of the steps shown in FIGS. 6-7). It will be understood that any other suitable software, hardware, or both may be used in place of or in addition to servers 192-196. The functionality of any network function (e.g., any one or more of AMF 182a-182b, SMF 183a-183b, and UPF 184a-184b) may at least be partially implemented in one or more of servers 192-196. Furthermore, a sensing network function, sensing data consumer, and a sensing processing entity may be at least partially implemented in one or more of servers 192-196. While a sensing network function provides functionalities described further below in this disclosure, it will be understood that at least some of the described functionalities may be implemented in other existing network functions. For example, a sensing network function may be implemented as part of an SMF. In certain representative embodiments, there need not be a standalone sensing network function, and the functionalities provided by a sensing network function may be implemented in other existing network functions (e.g., any one or more of AMF 182a-182b, SMF 183a-183b, and UPF 184a-184b). Moreover, a sensing data consumer may be configured to consume data within a network (e.g., within a 3GPP system); the sensing data consumer may be an application function or application server provided for an application. Additionally, as shown in FIG. 1E, “N” of Server N 196 may represent any suitable integer.

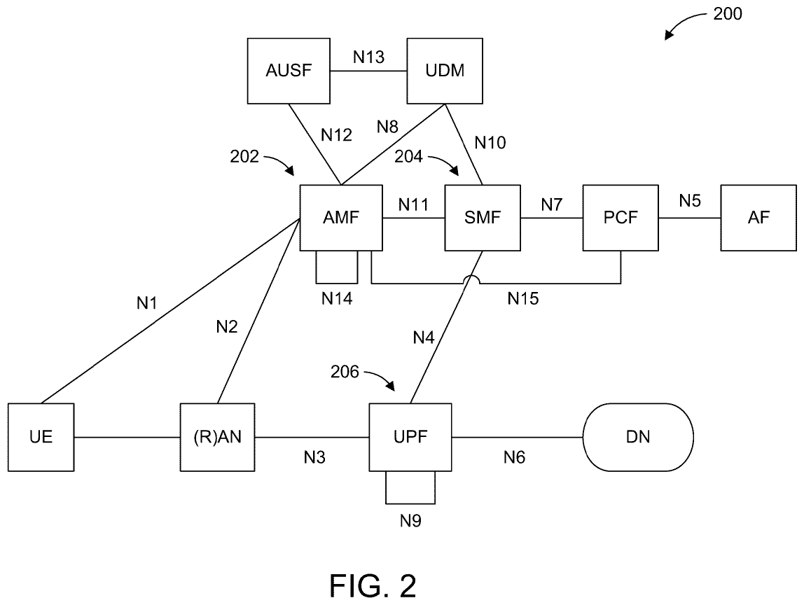

In view of the descriptions provided in connection with FIGS. 1A-1E, and further in view of the following descriptions provided in connection with FIGS. 2-7, it will be understood that a wireless network may include any suitable components and devices, including, for example, any of one or more base stations, one or more TRPs, one or more gNBs, one or more WTRUs, one or more AIoT devices, any other suitable device or component, or any combination thereof. It will be further understood that a component or device that is part of the wireless network can be referred to as communicating with the wireless network when it is communicating with any one or more other components or devices of the wireless network. For example, reference to a WTRU, which is part of the wireless network, transmitting or receiving signals to or from the wireless network refers to the WTRU transmitting or receiving signals, respectively, to or from any other component or device (e.g., another WTRU) of the wireless network.

In view of the descriptions provided in connection with FIGS. 1A-1E, and further in view of the following descriptions provided in connection with FIGS. 2-7, a node (e.g., of a wireless network) may generally refer to any physical component that communicates with any other physical component of a wireless network. For example, any physical component performing functions of the RAN or CN may be a node, a gNB may be a node, an eNB may be a node, a WTRU may be a node, a base station may be a node, a DNS server may be a node, and any other equipment configured to communicate with and/or provide a function of the wireless network may be a node. A node may be used interchangeably with an entity or device of the wireless network. In some instances, multiple aspects of the wireless network (e.g., a DNS server and equipment providing at least one function of the network, equipment providing multiple functions of the wireless network, or equipment providing multiple instances of a single function of the wireless network) may be collocated at a single node.

In view of the descriptions provided in connection with FIGS. 1A-1E, and further in view of the following descriptions provided in connection with FIGS. 2-7, certain functions are depicted and, e.g., associated with various devices or nodes, for illustrative purposes. It will be understood that network functions, in whole or in part, may be performed by any suitable device and/or may be performed at any suitable node.

It is noted that in this disclosure, the terms RAN Node, gNodeB, base station, access network (AN), next-generation RAN (NG-RAN) are used interchangeably.

In accordance with some embodiments of this disclosure, a reference model of wireless network, such as a 5G network or other suitable network, is shown in FIG. 2 and described as follows. FIG. 2 illustrates an example of a reference model of a network architecture (e.g., a 5G or NextGen network). As used in connection with FIG. 2, R(AN) here refers to a radio access network (e.g., based on the 5G RAT or Evolved E-UTRA) that connects to a wireless network (e.g., a NextGen core network). In certain representative embodiments, AMF 202 (e.g., which may be the same as AMF 182a or 182b) includes the functionalities of registration management, connection management, reachability management, and mobility management. In certain representative embodiments, SMF 204 (e.g., which may be the same as SMF 183a or 183b) includes the functionalities of session management (e.g., session establishment, modification, and release), UE IP address allocation, selection, and control of UPFs. In certain representative embodiments, UPF 206 (e.g., which may be the same as UPF 184a or 184b) includes the functionalities of packet routing, packet forwarding, packet inspection, and traffic usage reporting.

In certain representative embodiments of this disclosure, integrated sensing capabilities and potential systems, methods, and devices for enhancing capabilities for communicating with AIoT devices in wireless networks. For example, the enhancements may provide sensing services addressing different target verticals/applications (e.g., autonomous/assisted driving, vehicle-to-everything, unmanned aerial vehicles, 3D map, smart city, smart home, factories, healthcare, or maritime sector). In integrated sensing applications, there is a process of collecting sensing measurement data. The sensing measurement data, for example, may be data collected about radio/wireless signals impacted (e.g., reflected, refracted, diffracted) by an object or by an environment of interest for sensing purposes. A further example of generating sensing measurement data may be deriving sensing results from processing sensing measurement data. There may also be an area defined for sensing such as a sensing service area (SSA) location, which may be an area or location (with or without at least one obstacle) in which the SSA can provide sensing service with target quality.

Any entity can be considered in sensing applications and enhancements. Sensing of recognized or unrecognized entities can occur. For example, communicating with standardized entities (e.g., 3GPP entities) or non-standardized entities (e.g., non-3GPP entities, which may be considered as transparent to a fifth generation system (5GS)) can be accommodated by certain embodiments of this disclosure, such that the corresponding sensing measurement data may be communicated using any suitable protocol to an interface existing in any suitable wireless system, such as a 5GS.

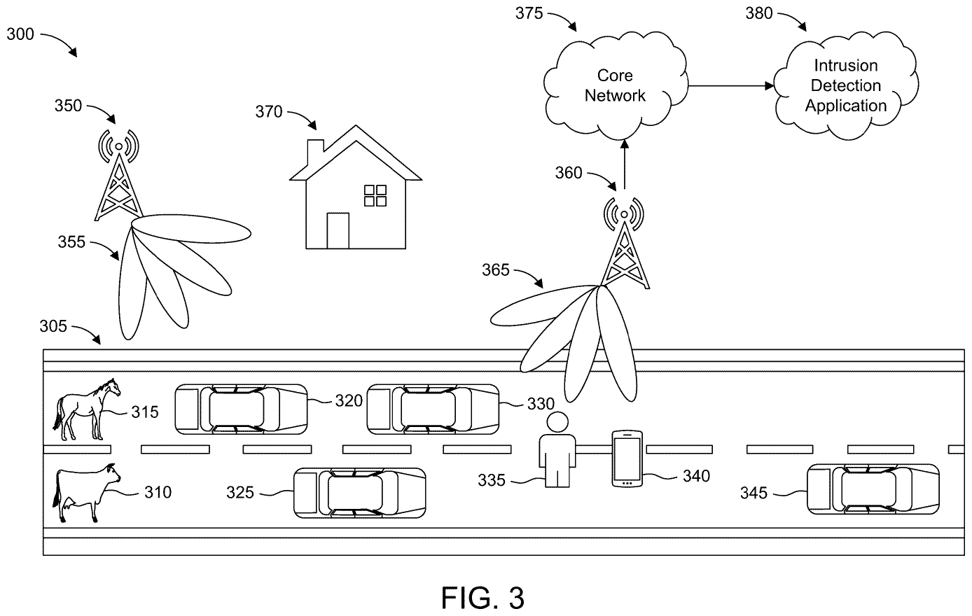

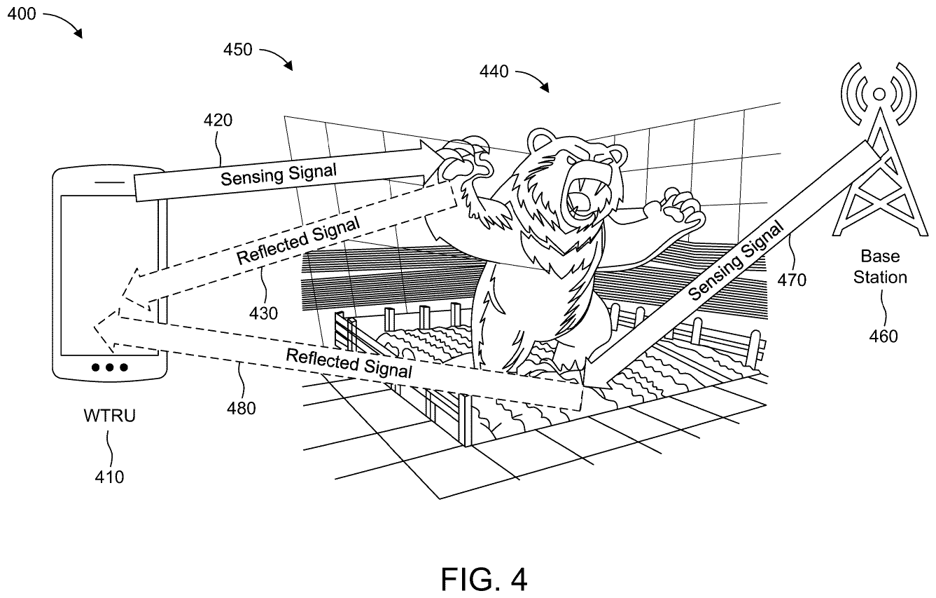

An illustrative use case for integrated sensing is object detection. For example, detection of pedestrian and/or animal intrusion detection on a highway (see, for example, FIG. 3), or detection of an intruder in surroundings of a smart home (see, for example, FIG. 4), are considered.

As shown in FIG. 3, for example, in an outdoor environment 300, pedestrian and/or animal intrusion detection is provided. Environment 300 includes highway 305 and residential property 370 adjacent to highway 305. Base station 350 (e.g., which may be the same as base station 114a or 114b) at a first location and base station 360 at a second location emit beams 355 and 365, respectively. Beams 355 and 365 interact with highway 305 and objects 310-345 on highway 305 such as first animal (e.g., cow) 310, second animal (e.g., horse) 315, first vehicle 320 traveling in a first direction (right-to-left on the page), second vehicle 325 traveling in a second direction (left-to-right) opposite the first direction, third vehicle 330 traveling in the first direction, pedestrian 335 traveling in the first direction, the pedestrian 335 carrying a WTRU 340 (e.g., which may be the same as WTRU 102a, 102b, 102c, or 102d), and fourth vehicle 345 traveling in the second direction. Information regarding highway 305, property 370, and objects 310-345 is transmitted by base station 360 (e.g., which may be the same as base station 114a or 114b)) to core network 375 (e.g., which may be the same as CN 106 or 115). Core network 375 transmits the information to intrusion detection application 380. Intrusion detection application 380 is configured to sense, identify, and/or track objects 310-345, for example, with respect to base stations 350, 360 and/or one or more fixed points along highway 305 and/or property 370. Intrusion detection application 380 may be configured to differentiate between different types of vehicles (e.g., compact vehicle 325 versus large vehicle 345) or different types of objects (e.g., horse 315 versus human 335) and corresponding locations, directions of movement, velocities, or the like.

As shown in FIG. 4, for example, in outdoor environment 400, intruder detection in surroundings 450 of a smart home is provided. Environment 400 includes WTRU 410 (e.g., which may be the same as WTRU 102a, 102b, 102c, 102d, or 340), intruder (e.g., a bear) 440, and base station 460. WTRU 410 is configured to transmit a sensing signal 420, which, in this example, is incident on intruder 440. WTRU 410 is configured to receive reflected signal 430, which, in this example, reflects sensing signal 420 after incidence with intruder 440. Base station 460 is configured to transmit sensing signal 470, which, in this example, is incident on surroundings (e.g., the ground) 450. WTRU 410 is configured to receive reflected signal 480, which, in this example, reflects sensing signal 470 after incidence with the surroundings 450.

In the scenarios of FIG. 3 and FIG. 4, base station (e.g., 350, 360, 460) and/or WTRU (e.g., 340, 410) can detect the intrusion of an object (e.g., cow 310, vehicle 320, bear 440) into the sensing area of the base station by itself or by collaboration between the WTRU and the base station. For example, the sensing measurement is transferred to the core network 375 and further processed into the sensing result.

In certain embodiments, transparent sensing is another use case for integrated sensing. In transparent sensing, sensing data is captured by a WTRU and communicated to a network, such that the network is made aware of the sensing information. The WTRU may acquire sensing measurements from recognized (e.g., as per a 3GPP indication) or unrecognized (e.g., as per a lack of indication, or for any non-3GPP indication). A network node, such as a fifth generation core (5GC) node, may determine various available sensing services by processing collated sensing data.

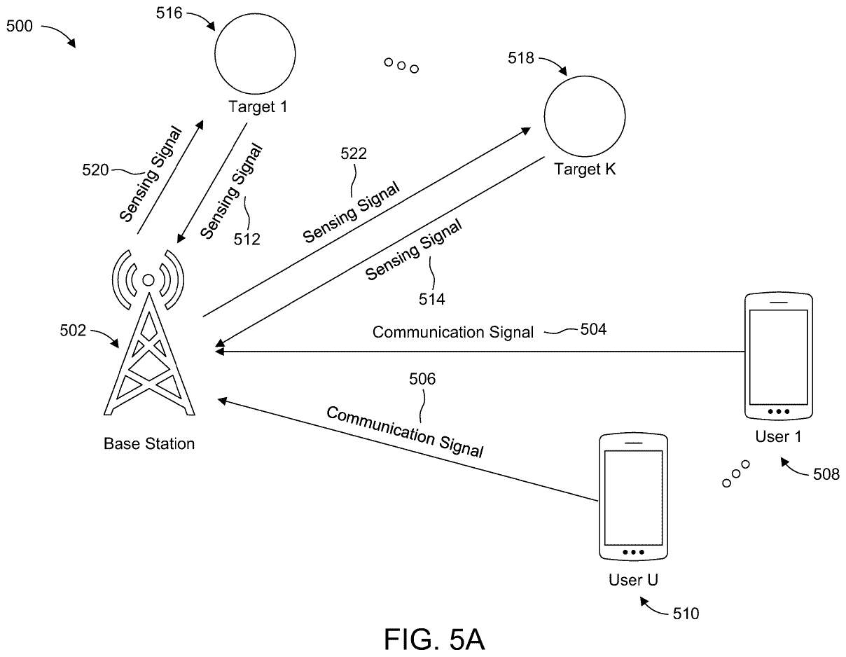

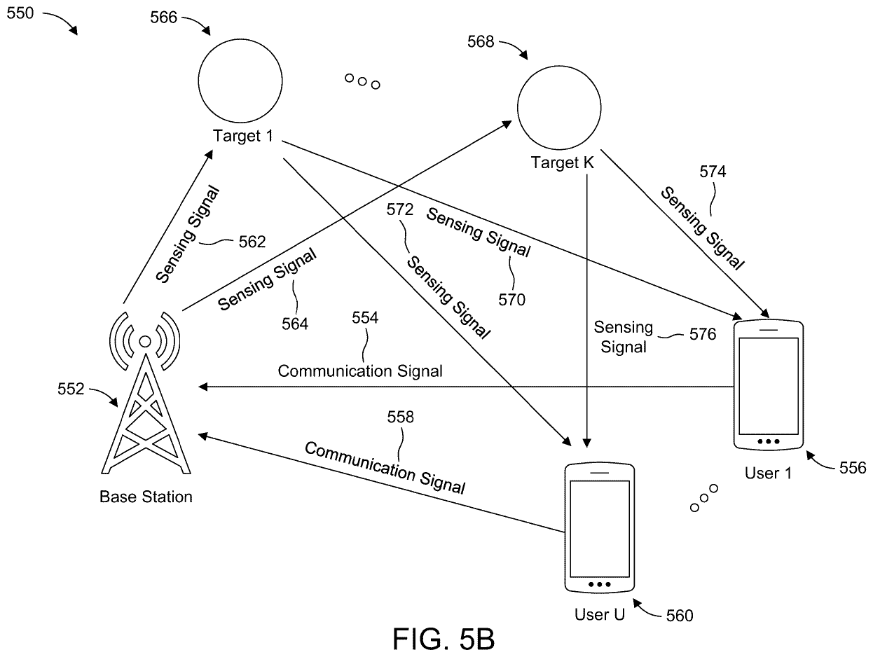

There are various modes of sensing, including monostatic sensing and bistatic sensing, as further shown in FIGS. 5A and 5B, respectively. In monostatic sensing, the sender and the receiver of the sensing signal are the same node. In bistatic sensing, the sender and the receiver of the sensing signal are two different nodes. Furthermore, multi-static sensing refers to any combination of monostatic or bistatic sensing modes involving one or more nodes. Each of those one or more nodes may be a base station, a WTRU, or any other suitable device.

FIG. 5A illustrates an example of monostatic sensing wherein the sensing signal sender and receiver are the same node according to some embodiments of the disclosure. For example, in environment 500, base station 502 (e.g., which may be the same as base station 114a, 114b, 350, 360, or 460) may send first sensing signal (e.g., sensing signal 520 or 522) and receive second sensing signal (e.g., sensing signal 512 or 514) as a reflection of the first signal. Base station 502 may also receive communication signals 504 and/or 506 from user devices 508 and 510, respectively. Communication signals 504 and/or 506 may indicate an outcome of a sensing operation, and/or may trigger a reconfiguration (e.g., including any suitable details of the reconfiguration). As shown in FIG. 5A, “K” of “Target K” and “U” of “User U” may represent any suitable integers. It will be understood that, for example, if U equals five, then there would be five respective user devices (although only two are shown for illustrative purposes). It will also be understood that, for example, if K equals three, there would be three respective targets (although only two are shown for illustrative purposes).

FIG. 5B illustrates an example of bi-static sensing wherein the sensing signal sender and sensing signal receiver are two different nodes. For example, in environment 550, base station 552 (e.g., which may be the same as base station 114a, 114b, or 502) may receive a communication signal 554 from user device 556 and receive communication signal 558 from user device 560. The base station 552 may also send first sensing signals 562 and 564 to targets 566 and 568, respectively. A target may reflect a first sensing signal to generate a second sensing signal (e.g., sensing signal 570 or 572) that may be recorded at a user device receiving the sensing signal. TAs shown in FIG. 5B, “K” of “Target K” and “U” of “User U” may represent any suitable integers. It will be understood that, for example, if U equals five, then there would be five respective user devices although only two are shown. It will also be understood that, for example, if K equals three, there would be three respective targets although only two are shown.

In this disclosure, sensing features refer to the physical features or properties of the sensing target (object, environment) that are reflected on the sensing data. The features and the properties sensed by a sensor node may change depending various factors in relation to the sensing target. For example, the location of a sensor node, with respect to the sensing target, may determine which part of the sensed object is visible to the sensor and which parts of the sensed object are hidden. Therefore, not all features of the target object may be detected by the sensor.

The features that are captured in the sensing data may also differ depending on the sensing capabilities of the sensor node. For example, two sensor nodes may be placed in identical locations, in relation to the target object, but the first sensor may be a radio sensor, which may accurately sense the materials used on the surface of the target object, while the second sensor may be a LIDAR sensor, which may accurately sense the relative distance between the second sensor and the target object.

Thus, a WTRU with various sensing capabilities may be configured to sense various properties (e.g., location, velocity, direction, material properties, temperature, sound emissions, or other suitable properties) of physical objects or the environment using various sensors independently. As further described below, the WTRU may be configured to construct PDU sets such that data from each respective sensor can be correlated with each other at the network.

Quality of service (QoS) parameters may be specified in a PDU set. PDU Set QoS parameters can be used to support PDU set-based QoS handling by an NG-RAN. At least one PDU set QoS parameter should be sent to the NG-RAN to enable PDU set-based QoS handling. Accordingly, the following PDU set QoS parameters may be configured: PDU set delay budget (PSDB), PDU set error rate (PSER), and PDU set integrated handling information (PSIHI). For a given QoS Flow, the values of PSDB, PSER and PSIHI can be different for uplink (UL) and downlink (DL) communications.

A QoS profile may include the PDU set QoS parameters described in this disclosure for UL and/or DL communication. The policy control function (PCF) can determine the PDU set QoS parameters based on information provided by an application function (AF) and/or a local configuration. The PDU set QoS parameters may be sent to the SMF as part of a policy and charging control (PCC) rule. The SMF can then sends the PDU set QoS parameters to NG-RAN as part of the QoS profile.

If the NG-RAN receives PDU set QoS parameters, it may be configured to provide the PDU set-based QoS handling and to apply the relevant PDU set QoS parameters.

In certain representative embodiments, PDU sets are provided in downlink communications, as further explained below.

To support PDU set based QoS-handling, the PDU session anchor (PSA) UPF identifies PDUs that belong to particular PDU sets and determines PDU set information. The UPF sends the PDU set information to the NG-RAN (e.g., in the general packet radio service tunneling protocol user plane (GTP-U) header). The PDU set information may be used by the NG-RAN for PDU set-based QoS handling, as described above.

The PDU set information may include any one or more of a PDU set sequence number, an indication of the end PDU of a PDU set, a PDU sequence number within a PDU set, a PDU set size (e.g., in bytes), or a PDU set importance (e.g., to identify the relative importance of a PDU set compared to other PDU sets within a QoS Flow).

The NG-RAN may use the priority level across QoS Flows and PDU set importance within a QoS flow for PDU set-level packet discarding (e.g., if the network is at a certain level of congestion).

The PDU set information can be different for different PDU sets within a QoS Flow.

The SMF may instruct the PSA UPF to perform PDU set marking, and the SMF may provide the PSA UPF with a protocol description to be used in connection with the service data flow. The protocol description may be received in the PCC rule, e.g., based on information provided by the AF or by PCF local policies.

The PSA UPF can identify the PDU set information using any one or more of the protocol description, the received transport protocol headers, the received payload, or implementation-specific approaches.

For each DL PDU received (e.g., via an N6 interface) where PDU set based QoS handling is indicated from the SMF, the PSA UPF may apply the rules for PDU set identification and provide the available PDU set information to the RAN in the GTP-U header.

The PSA UPF can be configured to assign a unique PDU set sequence number in the GTP-U header, e.g., for each PDU set of the QoS Flow.

In certain representative embodiments, PDU set-based QoS handling is provided, as further explained below.

An AF that is provided PDU set QoS parameters and/or a protocol description may be used in determining the PCC Rule by the PCF. The protocol description may be further used by the PSA UPF for identifying the PDU set information.

When the SMF receives the PCC rule, the SMF may bind the PCC rule to one or more QoS flow. If the PCC rule contains one or more PDU set QoS parameters (e.g., a PSER, PSDB and PSIHI), then the SMF may add these PDU set QoS parameters to the QoS profile of the QoS flow. Alternatively, the SMF may be configured to support PDU set based QoS handling without receiving PCC rules from a PCF.

For DL communications, the PSA UPF can identify PDUs that belong to PDU set and can marks them accordingly. If the PSA UPF receives a PDU that does not belong to a specific PDU set (e.g., as indicated in a protocol description, e.g., for PDU set identification), then the PSA UPF can still map this PDU to any suitable PDU set and can still determine the PDU set information for that PDU.

For UL communications, a WTRU may identify PDU sets, e.g., according to any device-specific configuration. In certain representative embodiments, the SMF may send a protocol description associated with the QoS rule to a WTRU.

PDU set-based QoS handling may be configured in a network (e.g., including, but not limited to, a 5GS) for WTRU or UE devices registered for network access (e.g., for 3GPP access) in association with an access PDU Session (e.g., in further association with an IP PDU session type).

Groups of data (i.e., each group of data having one or more data packets) of a given sensing target (e.g., an object that is being tracked in the environment) may be related to each other. It is desired for the sensing data consumer (UE, AF, or any intermediary processing node such as BS or a NF in the CN) to receive and associate such groups of data with each other. It is further desired that such an association occurs within a given time window, e.g., in response to receiving any two groups of data that are related to each other. The sensing data consumer may perform such an association to increase completeness, robustness, accuracy, the value of any QoS indicator, or any combination thereof, of a corresponding sensing task involving related groups of data.

Groups of related sensing data may include respective groups of data that were provided by a single sensing source/sensor. Groups of related sensing data may include respective groups of data belonging to multiple sensing entities that may serve the same task.

Consider a service requiring sensing info of an object's border (e.g., for detecting its relative distance to the surrounding environment). In certain embodiments, most or all of the information related to the object's border in a two-dimensional (2D) space should be received at a consumer application. In one example, changes in most or all “UV” coordinates (e.g., as in UV mapping of a three-dimensional (3D) space to two-dimensional coordinates, such as the mapping of two dimensional coordinates representing a moving human) based on sensed using radio signals should be received at the sensing processor to generate the updated image. In another example, respective groups of data from multiple sensors (e.g., at respective devices, or respective sensors of a single device) may monitor the same sensing target. The sensors could collectively generate 3D information, information of various surfaces of the same object, temporal information, sonic information, any other suitable information or any combination thereof. Because the respective groups of data monitor the same sensing target, they may be correlated in time, and they should each be provided to the sensing data consumer to support the consumer in constructing the whole sensing target.

A UE may have multiple integrated sensors, including sensors indicating or complying with a standard (e.g., 3GPP-based sensors) and sensors not indicating a standard or not complying with a standard (e.g., non-3GPP based sensors). The UE may support integrated applications for generating respective sensor data (e.g., and for integrating respective data groups that are related to each other, such as may occur at an enabler client). Each sensor may collect different types of data (e.g., RF sensing data, extended reality (XR) user position, camera images, depth maps, hand tracking, motion type, any other data, or any combination thereof). Some data may be processed and some data may be raw. Data packets are used to send the collected (i.e. sensed) information through a network (e.g., such as a 5G system). Each data packet (i.e., each PDU) is sent within a PDU session and a QoS flow. The network may be configured to receive each data packet with a particular QoS treatment. The QoS treatment may be based on the configuration of the QoS flow, the PDU itself, any other suitable indications, or any combination thereof.

In certain embodiments, QoS treatment approaches for data packets that carry sensing data do not consider that some parts of sensed data are correlated. Because of the nature of the correlation, such data may have its maximum usefulness for the receiver if all correlated parts of the data are received by the receiver. Moreover, some parts of sensed data should be received within a given time window (e.g., such that correlated packets are received sufficiently close in time to each other) to be maximally useful for the receiver.

In other words, if data correlation is not considered as part of QoS treatment, then when some groups of data are delayed or lost, it can lead to inefficient data collection and transmission in the network. For example, respective groups of correlated data packets may be treated differently in congestion situations due to a lack of recognition that these respective groups are correlated with each other. Application layer changes, e.g., to processing and buffering, may be available to improve QoS and/or quality of experience (QoE) when handling correlated data packets (e.g., within one or more PDU sets).

The PDU set feature may allow an application layer to indicate to the system that respective PDUs are part of the same PDU set. Being part of the same PDU set indicates at least some level correlation between the respective PDUs of the PDU set. A network can then use PDU set QoS parameters to make decisions about how the PDUs of the set are handled by the wireless network and/or by a consumer/receiver. For example, the PDU set QoS parameters can convey information to the network about how close in time the PDUs of the PDU set need to be delivered to the receiver (e.g., by establishing criteria for the PDU set delay budget or the PDU set integrated handling, which are two examples of relevant PDU set QoS parameters). PDU set QoS parameters can convey information to the network about a threshold portion of PDUs, within the PDU set, that need to be delivered to the receiver in order for the collective data to meet a given QoS or QoE specification.

In certain embodiments, the PDU set feature assumes that the application layer of a single application populates the headers of the application layer messages, and that the populated header information indicates, to the network, which messages are part of the same PDU set. In such embodiments, the application layer may need to use a protocol (e.g., RTP, possibly with specific RTP header extensions) to embed the PDU set information in the application layer traffic.

However, approaches that rely on (or otherwise assume/expect) a single application layer for sending all of the correlated packets may be suboptimal (or incapable of) grouping correlated packets that come from different sensors (e.g., different sensing applications running on one or more of the devices shown in FIGS. 5A, 5B).

Thus, in accordance with some representative embodiments of this disclosure, the PDU set feature is made suitable for sensing applications relying on at least two correlated groups of data.

As used herein, the terms application on the UE, sensing entity, and data producers are used interchangeably with reference to possible entities that can be executed on a WTRU to generate data that can be shared over UL communications.

Provided herein are procedures for sensing, integrated sensing and communication, and additional use cases such as multi-modal communication.

As used herein, a sensing data unit (SDU) refers to an interrelated data set (e.g., having at least two respective groups of data that are correlated with each other) that should be received and processed together by the sensing data consumer. PDU sets and/or PDU set-based procedures are provided for constructing PDU sets out of packets and/or PDUs containing such interrelated data sets. These PDU sets and/or PDU set-based procedures can provide PDU set-based traffic handling on any transmission path, as well as traffic handling by the receiver or by any suitable destination (e.g., including an NF or an application server (AS)).

Parameters that may be used (e.g., by a WTRU, or by any suitable wireless network function, which may itself be executed on the WTRU) for identifying interrelated sensing data (e.g., from one or from multiple sensing entities) may include any combination of: data in a specific time slot, e.g., to group all data that is provided within the time slot; data in a specific frame, e.g., to group all data that belongs to a sensing snapshot of a scene; data of a specific target object or a specific scene, e.g., to group all data that belong to a specific object in the scene; data related to a specific feature of a target object (e.g., UV coordinates along the object's border), e.g., to group all data that describe a specific surface of the target object; data related to a specific property of a target object (e.g., reflection of light, movement, speed), e.g., to group all data that may indicate the object's movement; data related to a specific sensing sub-area, e.g., to group all data that belong to a specific area within the sensing area; data associated a specific sensor or a specific group of sensors; fused data that could be sent to another processing system component for further fusion, e.g., with data from different groups, streams, devices, or databases; or any other suitable sensing or target object parameters.

In certain representative embodiments, application layer information can be used for grouping sensing data, as further described below.

RTP header extensions (HE) may be required for PDU set marking. RTP HE may also be provided to support XR services and applications when configuring PDU set-related parameters. The HE may include indications of: the last PDU of a PDU set, the last data packet of a data burst, a PDU set importance (PSI), a PDU set sequence number (PSSN), a PDU sequence number within a PDU set (PSN), a PDU set size (PSSize), a number of PDUs in the PDU set (NPDS), any other parameter related to a PDU, or any combination thereof.

A sensing entity may rely on existing RTP HE when sending sensing data over RTP. Alternatively, a sensing entity may introduce new header extensions (e.g., based on existing RTP HE) in other protocols that may be used for transmitting sensing, e.g., TCP/IP, UDP, IPv6, message queuing telemetry transport (MQTT), and Constrained Application Protocol (CoAP).

Additionally, sensing related fields may be introduced (e.g., to a header or a header extension). Moreover, existing fields (e.g., RTP ‘reserved’ HE., or any other field of a header) may be repurposed. Whether they are introduced or repurposed, sensing related fields may be included in a header or a in header extension to indicate any combination of: sensor identification (e.g., as an index that refers to a specific instance of a sensor); sensor or data type (e.g., to indicate the type of sensor or data, e.g., RF, lidar, radar); duplication (e.g., to indicate if the corresponding data can be derived from other data in the stream (e.g., data of an object gathered from a second sensor)); whether the data is processed or raw; a type of data processing (e.g., an index indicative of a type of compression, filtering, masking, anonymization, fusion, aggregation, other data processing, or any combination thereof); a correlation indicator (e.g., indicating how the data are grouped (e.g., correlations in time, scene, feature, surface, sensing area)); a level of processing (e.g., indicating an extend to which the data is processed, such as an indication of whether the processing is considered to be finalized); an indication of whether the data is 3GPP or non-3GPP sensing data; sensing task identification; sensing data priority level (e.g., such that the network can identify if and when to prioritize certain data over other data); or any combination thereof.

Moreover, with or without any of the indications above, sensing related fields may be included in a header or a in header extension to indicate a correlation identification (ID). For example, respective sensors (e.g., within a single WTRU, or across multiple WTRUs) that generate correlated data may be assigned a correlated sensing ID by the application layer. Therefore, all the correlated sensing entities can be preconfigured dynamically configured to be correlated by the network or by the application layer based on the correlation ID. In certain representative embodiments, the correlation ID is provided when establishing a PDU session, and respective groups of correlated data associated with the PDU session are thus treated with the same QoS.

The sensing-related fields (e.g., inclusive of one or more sensing-related parameter) as provided above can be specified (in any combination) individually for each sensing entity. Then, using the individualized sensing-related fields, respective sensing entities can be grouped together upon receipt of the respective groups of correlated data. Alternatively, shared sensing-related fields can be applied across a group of sensing entities. Then, using the shard sensing-related fields, respective sensing entities can be grouped together upon receipt of the respective groups of correlated data.

FIGS. 6A and 6B illustrate first and second parts, respectively, of a process 600 for constructing PDU sets at a sensing entity, according to one or more embodiments of this disclosure. It will be understood that FIGS. 6A and 6B are connected by box “A”, i.e., the steps shown directly above box “A” in FIG. 6A are followed by the steps shown directly below box “A” in FIG. 6B.

The sensing entity of FIGS. 6A-6B may be any WTRU 102, the UE of FIG. 2, WTRU 340, WTRU 410, user device 508, 510, 556, or 560, any other suitable WTRU, any other suitable UE, or any combination thereof. That is, a WTRU configured to construct PDU sets may include multiple sensing applications (i.e., N sensing applications, where N is any suitable integer), an enabler client, mobile equipment (e.g., which may include at least one sensor, and which may correspond to a UE or a component thereof), other suitable software or hardware, or any combination thereof.

The components other than the sensing entity, as used in connection with process 600, may be components (or subcomponents) of any suitable wireless network, including, but not limited to, the wireless networks shown in connection with FIGS. 1A, 1C, 1D, 1E, 2, 3, 4, 5A, 5B, or any combination thereof.

Consistent with the discussion above, it will be understood that if sensing data (e.g., as mentioned in step 0 of process 600) comes from multiple respective sensing entities, process 600 may be executed, in whole or in part, at each of the multiple respective sensing entities.

It will be understood that while various network entities are depicted as executing certain steps of process 600, comparable steps may be executed at any suitable node, function, and/or device of a wireless network.

The rightmost block in the top row of FIG. 6A shows how a wireless network node may include an application server (AS) that is collocated with a sensing enabler/configuration server; however, other physical implementations of the AS and/or the sensing enabler/configuration server (e.g., as being collocated with any function or device shown in connection with process 600) are contemplated. The sensing enabler/configuration server, as shown, may provide sensing data unit grouping information (e.g., QoS requirements), sensing data unit grouping policy information (e.g., from a PCF), any other data related to data correlation in sensing tasks, or any combination thereof.

At step 0 of process 600, sensing task initialization occurs.

Sensing task initialization can include a sensing application on the sensing entity providing information to be used for creating sensing data units, as described above (e.g., as may occur at the enabler client on the sensing entity). This information can be pre-configured in the sensing entity (e.g., during mobile termination), or this information can be received by the sensing entity over the network application layer.

Sensing task initialization can include a sensing entity registering its sensing capabilities (i.e., indicating any suitable standard sensing capabilities (e.g., 3GPP) or non-standardized sensing capabilities (e.g., non-3GPPP sensing capabilities)). This registration may indicate if the sensing entity will transmit respective groups of data from multiple sensors. This registration may further indicate respective information associated with multiple sensors participating in the sensing task (e.g., indicating sensor type as lidar, radio, camera, etc.).

Sensing task initialization can include the sensing entity receiving (e.g., from an AF or from an NF) a message indicating that it has been selected (e.g., by the sensing NF) for a sensing task. Such a message indication may also include which type of sensor data (e.g., a particular one or more sensors, a particular one or more degrees of processing, a particular one or more time windows, any other data type indication, or any combination thereof) is desired from the sensing entity.

Sensing task initialization can include the sensing entity receiving (e.g., from the sensing NF) information indicating one or more entities as being part of a particular sensing task. Such information may include an indication of one or more newly added sensing entities, which may or may not include the sensing entity receiving that information.

As shown, steps 1 through 6 of process 600 present as a first approach (i.e., “Option 1”) for configuring a sensing entity and/or a RAN node for grouping together correlated sensing data.

As shown, step 7 of process 600 present a second approach (i.e., “Option 2”) for configuring a sensing entity for grouping together correlated sensing data.

It will be understood that step 8 of process 600 may follow the operations of Option 1, and/or the operations of Option 2. That is, either or both of Options 1 and 2 may be executed in connection with process 600.

At step 1 of process 600, the AF provides information related to sensing data unit grouping, along with task information (e.g., any one or more of the QoS parameters described above) to the sensing NF via the NEF. The sensing NF sends the received information related to the sensing data unit grouping, along with task the information (e.g., at least one QoS parameter) to the SMF. The SMF may use the received information for managing sessions and QoS treatment of related data packets. Step 1 of process 600 may also specify, e.g., specific sensors from the sensing entity that have been chosen and grouped into one or more sensing data unit groupings.

At step 2 of process 600, the AF provides information related to sensing data unit grouping, along with task information (e.g., any one or more of the QoS parameters described above) to the PCF via the NEF. The PCF may use the received information when generating policy information for the sensing task. Rather than from the NEF, the PCF may receive this request from the sensing NF or any other NF. Based on the received information, the PCF may generate policy information related to the sensing task and may send the policy information to the SMF. The policy information may include information on how sensing data units may be created, as described above

At step 3 of process 600, the SMF determines that the PDU set feature should be enabled for particular QoS flows that are associated with the corresponding sensing task, based on information received in steps 1 and 2 of process 600.

At step 4 of process 600, the sensing entity receives, from the SMF, e.g., as part of the QoS rules, information related to QoS flows associated with the sensing task, information on PDU sets associated with the sensing task, information on QoS rules associated with the QoS flows (including other PDU set related parameters, such as PSI or PSDB, e.g., in the PDU session establishment/modification accept message), or any combination thereof. Step 4 of process 600 may include any suitable node of the network sending a message to the sensing entity indicating how PDU sets may be formed based on sensing data unit grouping information, as described above. The sensing entity may receive a QoS rule with multiple packet filters for sensing data from different sensors. The information received from the SMF may indicate that respective traffic from different packet filters should be mapped onto the same QoS flow. The information received from the SMF may indicate that the traffic from the packet filters should be grouped into PDU sets. The information received from the SMF may include sensing data grouping information to be used when determining how respective packets of sensing data should be arranged into groups, and how the arranged groups should be represented (e.g., configured for specific handling) within the group (e.g., which application layer protocol header information elements to use, and/or which PDU header markings to use for marking PDU sets).

In certain representative embodiments, step 4 of process 600 may also include the sensing entity receiving an indication that the sensing data should be added into a specific sensing QoS flow, with or without any other traffic.

In certain representative embodiments, step 4 of process 600 may also include the sensing entity receiving an indication that the sensing data should be added into a specific QoS flow, e.g., which only includes data from specified applications (e.g., with other application data related to the same sensing task).

At step 5 of process 600, as shown, the mobile equipment (ME) component of the sensing entity part sends PDU set/sensing data unit grouping information to the enabler client component of the sensing entity, along with other QoS related information (e.g., PSI, PSDB).

At step 6 of process 600, the SMF sends QoS, PDU set, and PDU set QoS parameters to the NG-RAN, along with information related to the sensing task. The corresponding message may indicate that a specific PDU set, and/or PDU set integrated handling, is configured for the corresponding QoS flows. That message may also include information described in step 4 of process 600.

At step 7 of process 600, the sensing enabler/configuration server causes the enabler client on the sensing entity to be configured with information indicating respective data traffic (e.g., as associated from respective applications) that should be grouped together into a PDU set. The corresponding message may, e.g., indicate which (QoS or other) parameters are to be used when grouping packets, as described above.

Additional details pertaining to the use of Options 1 and 2 of process 600 are provided below. Option 1 may be executed when a sensing entity is in communication with an SMF. Option 2 may be executed when a sensing enabler/configuration server (i.e., an enabler server, for short) is in direct communication with the enabler client of the sensing entity (e.g., over a protocol-based network connection (e.g., a 3GPP connection), or over any other suitable network connection (e.g., a non-3GPP access connection)). Through the direct communication, the enabler sever can configure the enabler client of the sensing entity with the grouping information, including, but not limited to, any of the QoS parameters provided above, and/or at least one sensing related parameter as described above.

Whether the sensing entity receives sensing data grouping information as per Option 1 or Option 2, the sensing entity may use the information to determine one or more sensing group (e.g., each including at least two related groups of data). In certain representative embodiments, the sensing entity assigns a correlation ID to each sensing group and informs the enabler sever of the correlation ID. In certain representative embodiments, the sensing entity sends sensing details (e.g., sensing capability, available sensors on the sensing entity, relationships between the various available sensors) to the enabler server, and the enabler server assigns a correlation ID to each sensing group. Based on the sensing entity receiving at least one correlation ID from the enabler server, the sensing entity may initiate a PDU set activation request to the SMF. The SMF may be configured to, based on receiving the PDU set activation request, obtain required sensing or QoS parameters (e.g., from the sensing NF or the AF).

At step 8 of process 600, the enabler client provides information related to sensing data grouping to the application.

At step 9 of process 600, one or more sensing application, sensor, or any other data-producing component of the sensing entity, or any combination thereof, begin generating data to be sent over uplink sensing data communications.

At step 10 of process 600, the one or more data-producing components send sensing data to the enabler client. Sending sensing data may include sending metadata, e.g., the metadata indicating any suitable characteristics of the data (e.g., time stamp, sensor settings, location information, resolution, confidence interval, degree of processing, type of sensor, other suitable characteristics, or any combination thereof).

At step 11 of process 600, the enabler client of the sensing entity adds PDU set information (e.g., as a new header, or as components of an existing header) to the data generated at step 9 of process 600 (or to data generated based on that data, e.g., at step 10 of process 600). As shown, step 11 of process 600 typically occurs before the corresponding traffic is sent from the sensing entity to any suitable node of the wireless network. This operation at step 11 of process 600 may include constructing one or more PDU sets based on a configuration received at step 5 of process 600 and/or received at step 7 of process 600.

At step 12 of process 600, the sensing entity applies PDU set-based QoS treatment to the data traffic, ands send that treated traffic to the wireless network (e.g., to an NF and/or to an AS, via UL communication). For example, the sensing entity may use PSI values associated with PDU sets when applying QoS treatment to data traffic, e.g., for managing network resources.

FIG. 7 illustrates steps of a process 700 for constructing PDU sets at a WTRU, according to one or more embodiments of this disclosure. Process 700 may be executed by any WTRU 102, the UE of FIG. 2, WTRU 340, WTRU 410, user device 508, 510, 556, or 560, the sensing entity of process 600, any other suitable WTRU, any other suitable UE, or any combination thereof.

The wireless network, as mentioned in connection with process 700, may be any suitable wireless network, including, but not limited to, the wireless networks (in whole or in part) shown or described in connection with FIGS. 1A, 1C, 1D, 1E, 2, 3, 4, 5A, 5B, 6A, 6B, or any combination thereof.

At step 702 of process 700, a WTRU receives, from a wireless network, sensing data grouping information. Step 702 of process 700 may correspond to step 4 of process 600 (e.g., the sensing data grouping information may be a PDU set activation request), and/or step 5 of process 600. Step 702 of process 700 may correspond to step 7 of process 600. Step 702 of process 700 may also include sensing task initialization (e.g., corresponding to step 0 of process 600).

Step 702 of process 700 may include sharing data between multiple components of the WTRU (e.g., from at least one sensing application of the WTRU to an enabler client of the WTRU, from mobile equipment of the WTRU to the enabler client of the WTRU, and/or from the enabler client of the WTRU to the at least one sensing application of the WTRU).

Step 702 of process 700 may include, e.g., as part of the sensing data grouping information, an indication that multiple sensors of the WTRU will support the sensing task.

At step 704 of process 700, the WTRU generates, based on the sensing data grouping information, sensing data associated with a sensing task, wherein the sensing data includes a plurality of sensing data portions. The respective sensing data portions may, e.g., come from respective sensors of the WTRU (e.g., as may be lumped together within a mobile equipment block of the WTRU), and/or from multiple respective sensing applications of the WTRU. The respective sensing data portions may be associated with each other based on capturing different aspects (e.g., different signal types, or different regions) of the same target, based on reporting different characteristics of a shared signal (e.g., different resolution, or different degrees of processing), based on being fused together (e.g., to support a fused sensing task), based on having a shared QoS, or based on any other suitable criterion including, but not limited to, all the association criteria described in this disclosure.

Step 704 of process 700 may correspond to step 9 of process 600.

At step 706 of process 700, the WTRU generates at least one protocol data unit (PDU) set that includes the plurality of sensing data portions and PDU set information, wherein the PDU set information indicates a respective grouping for each of the plurality of sensing data portions.

Step 706 of process 700 may effectively result in the WTRU associating the respective sensing data portions with each other, based on the sensing data grouping information.

Step 706 of process 700 may correspond to step 11 of process 600, and optionally step 10 of process 600.

At step 708 of process 700, the WTRU transmits, to the wireless network as part of a PDU session, the at least one PDU set according to at least one set of quality of service (QoS) rules, where each set of QoS rules of the at least one set of QoS rules is applied to a respective grouping of the at least one PDU set.

Step 708 of process 700 may correspond to step 12 of process 60. That is, communicating the at least one PDU set to the wireless network may include applying a PDU set-based QoS treatment and sending the sensing data portions, with the PDU set information, according to the at least one set of QoS rules, to the wireless network.

In certain representative embodiments, generating the at least one PDU set at step 706 includes indicating the sensing data group information and/or the PDU set information in a message header of at least one message of the PDU session. For example, transmitting the at least one PDU set to the wireless network includes (e.g., within the PDU session) sending a message including the message header to the wireless network.

In certain representative embodiments, the WTRU may include N sensors (e.g., each of which may be a subcomponent of mobile equipment of the WTRU) and/or M sensing applications, and the WTRU may be configured to construct at least 1 through N*M respective sensing data portions based on the available sensors and/or sensing applications. In other words, the plurality of sensing data portions may include respective sensing data portions from respective sensors and/or respective sensing applications of the WTRU. While each sensor may map to a corresponding sensing application, a single sensor may also map to multiple sensing applications, and/or a single sensing application may also support multiple sensors.

The WTRU may also include an enabler client that is configured to communicate with the sensors and/or the sensing applications to retrieve the sensor data. The enabler client may be further configured to construct the PDU set (e.g., to apply at least a portion of the PDU set information to the respective sensing data portions) based on the sensing group information.

In certain representative embodiments, a WTRU (e.g., operating as a UE reader) performs the following operations to support a wireless network in selecting the WTRU for contributing to AIoT service requests: receive a configuration including the AIoT service area(s) which indicates the location (i.e., a specific area) where the WTRU should perform AIoT reader activities; monitor whether or not the WTRU is within of the configured AIoT service areas, e.g., by periodically checking the current location against the configured areas; and report to the wireless network whether or not the WTRU is within the configured AIoT service areas. If the WTRU is within at least one configured AIoT service area, then the WTRU may perform an operation based on the AIoT service request.

In certain representative embodiments, a node (e.g., the AIoTF) of a wireless network (e.g., of a fifth-generation core) performs the following actions to select a WTRU (e.g., to operate as a the UE reader) for AIoT service requests: receive an AIoT service request from the AF, where the request indicates an AIoT target area; locates the AMF(s) that serves the AIoT target area and request those AMFs to provide a list of available WTRUs (e.g., to operate as UE readers); receive a list of available WTRIs from the AMF(s), where the AMF selects the available WTRUs by checking whether their current AIoT service area is in or overlaps with the AIoT target area; select at least one WTRU based on the list of available WTRUs; and forward the AIoT service request to the selected WTRU.

As used herein, data (e.g., one or more groups, streams, flows, or packets of data) may be described as correlated, related, or interrelated, or using similar terminology. It will be understood that those relation-based terms are used to broadly indicate any form of association between two respective portions of data (or between two respective sub-portions of a single portion of data). Many examples are provided to illustrate how or why the association exists between the two respective portions of data, but these examples are merely illustrative, and certain embodiments of the present disclosure may be applied for any association between respective portions of data.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method performed by a wireless transmit/receive unit (WTRU), the method comprising:
receiving, from a wireless network, sensing data grouping information;
generating sensing data associated with a sensing task, wherein the sensing data comprises a plurality of sensing data portions;
generating, based on the sensing data grouping information, at least one protocol data unit (PDU) set that comprises the plurality of sensing data portions and PDU set information, wherein the PDU set information indicates a respective grouping for each of the plurality of sensing data portions; and
transmitting, to the wireless network as part of a PDU session, the at least one PDU set according to at least one set of quality of service (QoS) rules, wherein each set of QoS rules of the at least one set of QoS rules is applied to a respective grouping of the at least one PDU set.

2. The method of claim 1, wherein transmitting the at least one PDU set according to at least one set of QoS rules comprises applying each of the at least one PDU set to a shared QoS flow.

3. The method of claim 1, wherein receiving the sensing data grouping information comprises receiving, at an enabler client of the WTRU, the sensing data grouping information, and wherein the method further comprises receiving, at the enabler client, information about at least one sensor or about at least one type of sensing data from a sensing application of the WTRU.

4. The method of claim 1, further comprising communicating the sensing data grouping information from an enabler client of the WTRU to a sensing application of the WTRU.

5. The method of claim 1, further comprising communicating the plurality of sensing data portions from a sensing application of the WTRU to an enabler client of the WTRU.

6. The method of claim 1, wherein generating the at least one PDU set comprises indicating the PDU set information in a header of at least one message of the PDU session.

7. The method of claim 1, wherein the PDU set information comprises an indication of at least one of: a last PDU of the at least one PDU set, a last data burst of the at least one PDU set, an importance of the at least one PDU set, at least one sequence number of the at least one PDU set, at least one size of the at least one PDU set, or a number of PDUs in the at least one PDU set.

8. The method of claim 1, wherein the sensing data grouping information comprises at least one of: a time slot, a data frame, a target object, a target scene, a target object feature, a target object property, a sensing sub-area, a sensor, a type of sensing data, a degree of fusion, a degree of processing, a type of processing, a degree of duplication, a correlation indicator, a correlation identification, at least one sensing data priority level, or a sensing task identification.

9. The method of claim 1, further comprising determining, based on the sensing group information, sensing data portions of the plurality of sensing data portions to include in the at least one PDU set.

10. The method of claim 1, wherein:
the sensing data grouping information comprises an indication that a plurality of sensors of the WTRU will support the sensing task; and
the plurality of sensing data portions comprises respective sensing data portions from respective sensors of the plurality of sensors.

11. A wireless transmit/receive unit (WTRU) comprising processing circuitry and communication circuitry, the WTRU configured to:
receive, from a wireless network, sensing data grouping information;
generate sensing data associated with a sensing task, wherein the sensing data comprises a plurality of sensing data portions;
generate, based on the sensing data grouping information, at least one protocol data unit (PDU) set that comprises the plurality of sensing data portions and PDU set information, wherein the PDU set information indicates a respective grouping for each of the plurality of sensing data portions; and
transmit, to the wireless network as part of a PDU session, the at least one PDU set according to at least one set of quality of service (QoS) rules, wherein each set of QoS rules of the at least one set of QoS rules is applied to a respective grouping of the at least one PDU set.

12. The WTRU of claim 11, wherein to transmit the at least one PDU set according to at least one set of QoS rules comprises applying each of the at least one PDU set to a shared QoS flow.

13. The WTRU of claim 11, wherein to receive sensing data grouping information comprises receiving, at an enabler client of the WTRU, the sensing data grouping information, and wherein the WTRU is further configured to receive, at the enabler client, information about at least one sensor or about at least one type of sensing data from a sensing application of the WTRU.

14. The WTRU of claim 11, wherein the WTRU is further configured to communicate the sensing data grouping information from an enabler client of the WTRU to a sensing application of the WTRU.

15. The WTRU of claim 11, wherein the WTRU is further configured to communicate the plurality of sensing data portions from a sensing application of the WTRU to an enabler client of the WTRU.

16. The WTRU of claim 11, wherein to generate the at least one PDU set comprises indicating the PDU set information in a header of at least one message of the PDU session.

17. The WTRU of claim 11, wherein the PDU set information comprises an indication of at least one of: a last PDU of the at least one PDU set, a last data burst of the at least one PDU set, an importance of the at least one PDU set, at least one sequence number of the at least one PDU set, at least one size of the at least one PDU set, or a number of PDUs in the at least one PDU set.

18. The WTRU of claim 11, wherein the sensing data grouping information comprises at least one of: a time slot, a data frame, a target object, a target scene, a target object feature, a target object property, a sensing sub-area, a sensor, a type of sensing data, a degree of fusion, a degree of processing, a type of processing, a degree of duplication, a correlation indicator, a correlation identification, at least one sensing data priority level, or a sensing task identification.

19. The WTRU of claim 11, wherein the WTRU is further configured to determine, based on the sensing group information, sensing data portions of the plurality of sensing data portions to include in the at least one PDU set.

20. The WTRU of claim 11, wherein:
the sensing data grouping information comprises an indication that a plurality of sensors of the WTRU will support the sensing task; and
the plurality of sensing data portions comprises respective sensing data portions from respective sensors of the plurality of sensors.
